(19) United States
(12) Patent Application Publication
(10) Pub. No.: US 2008/0188981 A1
(43) Pub. Date: Aug. 7, 2008

(54) Cell Auditing System and Method for Storage Library Systems

(76) Inventor: Roland Herbert Sautner, Singen (DE)

Correspondence Address: THELEN REID BROWN RAYSMAN & STEINER LLP, P.O. BOX 640640, SAN JOSE, CA, 95164-0640, US

(21) Appl. No.: 11/670,993

(22) Filed: Feb. 4, 2007

(51) Int. Cl. G06F 19/00

(52) U.S. Cl. 700/245; 901/6

(57) ABSTRACT

A method of auditing cartridges and empty cells in a storage library system including a plurality cells for storing cartridges and further including a robotically actuated picker assembly, the method comprising:
providing a radio frequency sensor on the picker assembly;
positioning a cartridge having at least one radio emitting chip within the cells so that the presence of the radio emitting chip can be detected without unloading the cartridge from the cells and
operating the picker in a manner to search for the presence of the radio emitting chip within each cell for auditing numbers of cartridges and empty cells in the storage library system by moving the picker with the radio frequency sensor from one cell to the next to measure the presence of the radio emitting chip for each cell.

### TECHNICAL FIELD

The present invention relates to a method and apparatus for auditing cartridges and empty cells in a storage library system which includes a robotically picker assembly.

### BACKGROUND OF THE INVENTION

Storage library systems are capable of storing and rapidly retrieving large quantities of information stored on storage media cartridges. Such storage library systems often use robotic mechanisms to improve the speed of information retrieval and the reliability of maintaining the storage library cartridge inventory. These robotic mechanisms typically comprise a picker mechanism positioned on a robotically movable arm. To retrieve information, the robotic arm is moved to position the picker near the inventory location of a desired media cartridge. The picker is then activated to grip the desired cartridge and move it from the library inventory location to another location or to a tape drive for storing data. The robotic arm with the picker gripping the cartridge then moves to an appropriate position to further process the cartridge. In this manner, the robotic picker manipulates the cartridge for access to information stored on the cartridge.

The inventory locations typically comprise cartridge storing cells provided in a stacked arrangement for convenient storage of large numbers of cartridges.

When performing a tape audit in a storage library system, it is necessary for the system to distinguish between unlabeled cartridges and empty cell locations. To pickerle a large amount of tapes the tapes are very often labelled with a barcode to identify the content without loading the tape into a drive and reading the inventory/identity of the tape. Historically, this has been accomplished by either having the robotically actuated picker assembly reach into each cell and mechanically sense whether or not a cartridge is present, or by using a proximity sensor mounted to the picker assembly which is dedicated to this function or by using a reserved barcode at the end of the empty cell (U.S. Pat. No. 5,814,171), which identifies a empty cell.

Extending the robotically actuated picker assembly into each cell for auditing purposes adds significant delay to the machine audit time, and using a proximity sensor mounted to the picker assembly for auditing adds significant cost to the system and requires factory calibration.

The use of a barcode requires a barcode reader on top of the picker.

Further application on this field are:
U.S. Pat. No. 7,117,068 System and method for library robotics positional accuracy using parallax viewing U.S. Pat. No. 7,111,781 System and method for library inventory;
U.S. Pat. No. 6,937,411 Method, system, program, and storage cartridge for storing data in a storage medium;
U.S. Pat. No. 6,816,332 Vertical and horizontal path sensing within a data storage and retrieval system;
U.S. Pat. No. 6,762,691 Method and system for automatically locating equipment stored in a rack;
U.S. Pat. No. 6,724,315 Identification of mounting locations of sub-systems in mounting units;
U.S. Pat. No. 6,512,963 Library system having empty cartridge storage cell coded label stripe;
U.S. Pat. No. 6,213,705 Tape storage library apparatus having integrated camera, proximity sensor, and reach safe sensor;
U.S. Pat. No. 5,814,171 Cell auditing scheme for storage library system.

Accordingly, it is desirable to provide an inexpensive method and apparatus for auditing cartridges and empty cells in a storage library system in a manner which improves upon system audit time.

### DISCLOSURE OF THE INVENTION

The present invention overcomes the above-referenced shortcomings of prior art storage library systems by taking advantage of Radio Frequency Sensor, that is actuated by a Radio Frequency emitting label in or on the tape. Accordingly, an inexpensive solution to the above-referenced storage library system auditing problem is achieved while improving system auditing time.

More specifically, the present invention provides a method of auditing cartridges and empty cells in a storage library system including a plurality of stacked cells for storing cartridges and further including a robotically actuated picker assembly. The method comprises: (1) providing a radio frequency sensor on the picker assembly; (2) positioning a cartridge having at least one radio emitting chip within the cells so that the presence of the radio emitting chip can be detected without unloading the cartridge from the cells and (3) operating the picker in a manner to search for the presence of the radio emitting chip within each cell for auditing numbers of cartridges and empty cells in the storage library system, by moving the picker with the radio frequency sensor from one cell to the next measuring the presence of the radio emitting chip for each cell.

The present invention further provides an apparatus for auditing cartridges and empty cells in a storage library system including a robotically actuated picker assembly. The apparatus comprises a radio frequency sensor secured to the picker assembly. The cartridges within the cells have at least one radio emitting chip. So picker assembly is moved so that the presence of the radio emitting chip can be detected without unloading the cartridge from the cells

The picker is operated in a manner to search for the presence of the radio emitting chip within each cell for auditing numbers of cartridges and empty cells in the storage library system by moving the picker with the radio frequency sensor from one cell to the next and measuring the presence of the radio emitting chip for each cell.

In one possible embodiment the chip is a memory chip being reprogrammable by a high frequency. This chip is normally used by the tape drive to get information for calibration process of the tape drive (LTO drives (Linear Tape Open)). For each tape the calibration information might be different. So the tape drive can read the information and adapt the position of its head very quickly. This chip is similar to a RFID chip and needs a very powerful signal to operate reliably. To communicate with the drive a serial transmission protocol is used. A carrier signal of 13,56 MHz is turned off periodically. The data information to the memory chip is included in the signal blending to a start bit. The memory chip answers to the signal of the sender, by loading the data bits on the received carrier signal in a predefined cycle. This load can be detected by the sender, since the sender is located very close (the tape is loaded into the drive) to read the transmitted information. The modulate data signal is transferred with a speed of up to 850 Kbit/s, which leads to high performance requirements of the sender.

Based on this principle the radio frequency sensor detects the presents of the chip. The chip uses the power of a radio carrier signal to operate and the energy consumption of the chip is measured by the radio frequency sensor to detect the presence of the chip. The chip of LTO tapes is consuming power also when being in idle condition.

Therefore the radio frequency sensor comprises an antenna which is moved along the cells, wherein a load change indicates a cartridge within a cell. The measurement can be performed digitally or analogous. The analogues approach has the advantage that the diction is more stable with respect to long-term variations and environmental influences.

Furthermore a threshold can be defined to indicate that a memory chip has been passed.

Furthermore the interpretation of measured information is performed in relation to the position of the picker to eliminate errors. Since the cartridges are located in the slots of the library, the exact location of the chip can determined. The robotic knows the coordinates of the slots and consequently also the coordinates of the cartridges within the slots. Since the location of the chip on or within the cartridges is also defined the position of the slots can be calculated.

This information allows calculating the closest possible position of the radio frequency sensor to the chip inducing the strongest signal and allowing eliminating errors if the sensor is too far away from a possible chip.

Furthermore this information can be used to determine an optimized moving path of the robotically actuated picker assembly. The moving path is calculated based on shortest way to the closest possible position of the radio frequency sensor to the chips.

In another embodiment the carrier signal of the radio frequency sensor is generated by oscillator to match the resonant frequency of the chip.

Accordingly, an object of the present invention is to provide a method and apparatus for auditing cartridges and empty cells in a storage library system which improves system auditing time without substantially increasing cost.

The above object and other objects, features, and advantages of the present invention are readily apparent from the following detailed description of possible mode for carrying out the invention when taken in connection with the accompanying drawings.

### BRIEF DESCRIPTION OF THE DRAWINGS

FIG. 1a shows the sender signal;

FIG. 1b shows the answer of the receiver as a modulated load

FIG. 2 shows to test circuitry;

FIG. 3 shows the test circuitry in front of a LTO tape cartridge;

FIG. 4 shows the curve of the load in relation to the movement of the radio frequency sensor on the picker assembly;

FIG. 5 shows the steps of the method;

FIG. 6a shows a movement shows a library from the top,

FIG. 6b shows to robot in front of the cartridges;

FIG. 7 shows a the picker assembly with the the radio frequency sensor;

### DETAILED DESCRIPTION

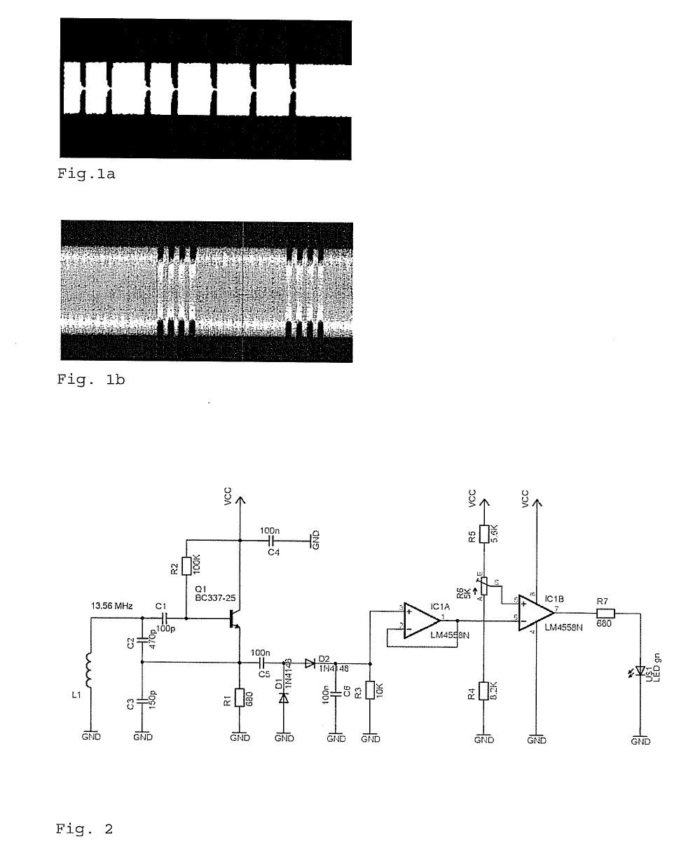

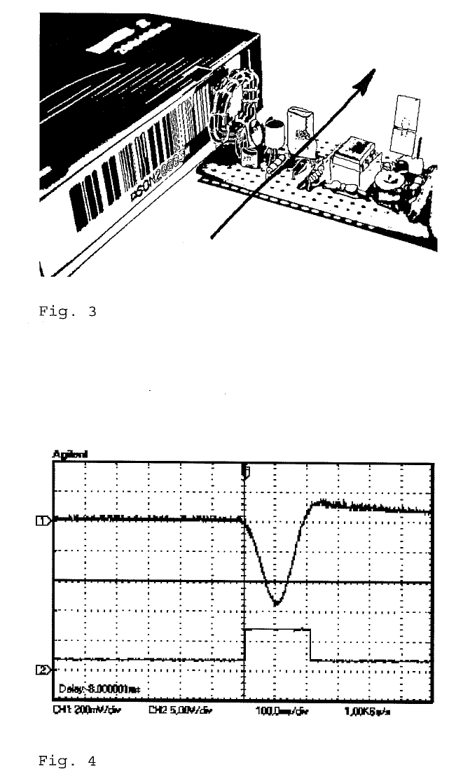

FIG. 1a shows the sender signal transmitting information using a serial transmission protocol. The carrier signal of 13.56 MHZ is periodically turn off. As mentioned above the data information is included in the phasing. FIG. 2 shows the answer of the receiver as a modulated load onto the sender signal. The load has got a feedback to the sender, since the sender is close by. This feedback can be evaluated to determine the transferred information.

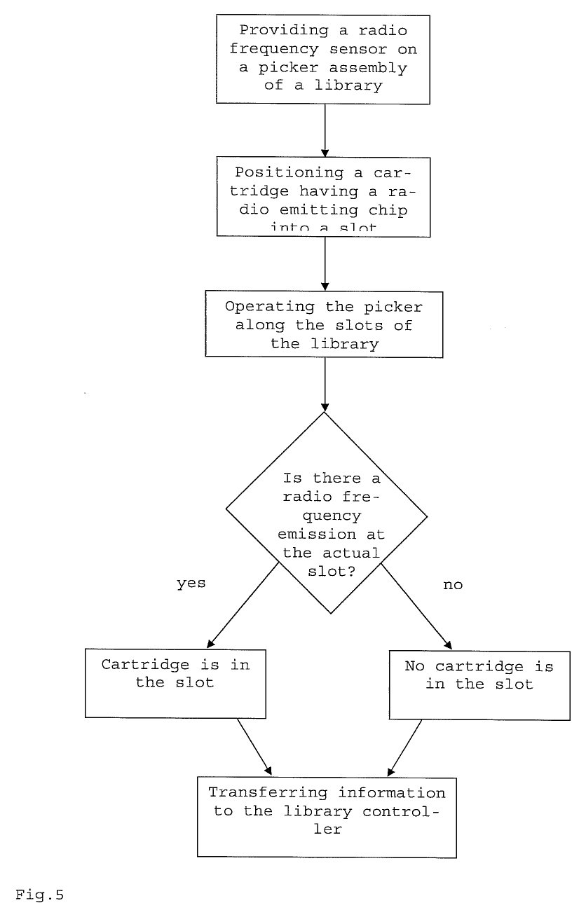

Turning to FIGS. 2 shows a circuitry of a prototype, determining the presence of a tape cartridge in a slot by turning on a LED. The transistor Q1 works as a colpitts oscillator. Induction element L1 and capacitor C2 and C3 provide an oscillating circuitry generating 13.56 MHz. L1 has also the function of an antenna and emits the carrier signal to the cartridge. From the resistor R1 the signal of the oscillator is derived using C5 and is rectified. IC1B works as comparator, and activates the LED if the rectified HF signal is below the preset reference level. This happens if the power of the oscillator is consumed by the cartridge memory, as shown in FIG. 3 and FIG. 4.

FIG. 3 shows the test circuitry in front of an LTO tape being moved in the direction of the arrow. The FIG. 4 shows the voltage drop when the antenna is very close the memory chip.

FIG. 5 shows the process steps of the cartridge auditing. In the last step the collected information is transferred to the library controller that provides the information to the library management or backup software. The software is now enabled to send the right transfer commands to the library picking a tape and moving the tape to the tape drive or vice versa.

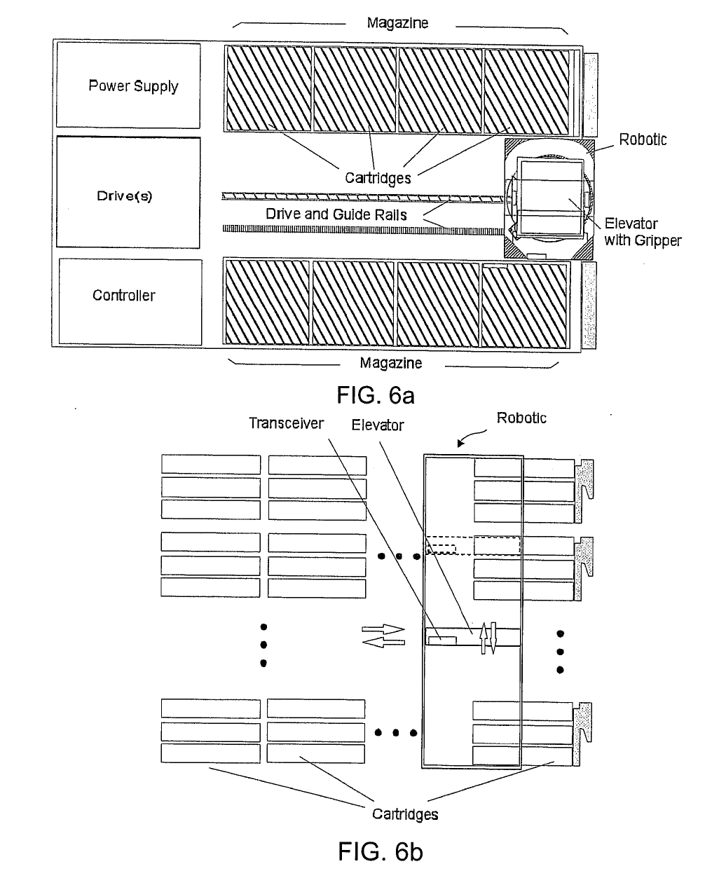

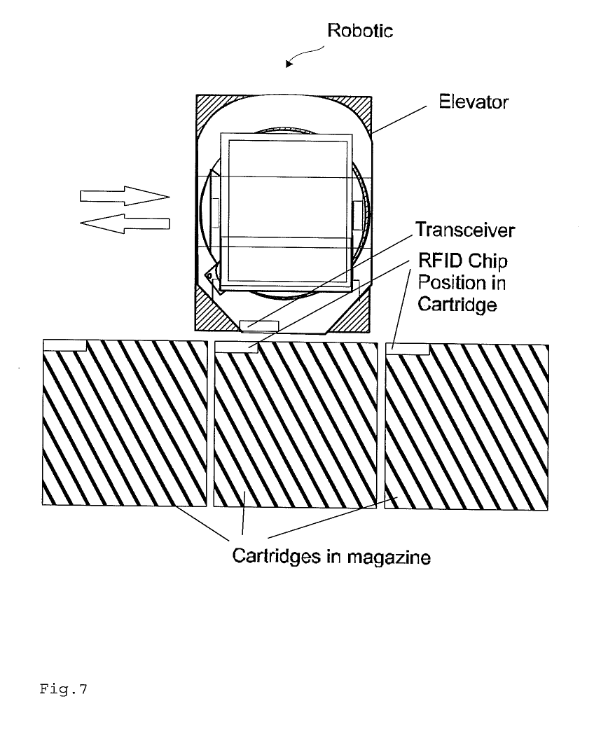

The FIG. 6a shows an open library form the top. At the back side of the library (left side of the FIG. 56a) a power supply drives and a library controller is located. Two magazines are located on each side storing tape cartridges. The robotic is moving between the two magazines towards the drive guided by a guiding sledge. The robotic can be lifted up and down with the elevator and can rotate to push the gripped tapes into the drive.

The FIG. 6b shows the sectional view along the guiding track. The elevator with the gripper can be moved up and down in front of the tapes. The gripper has an transceiver that detects if a tape is present in the slots.

The FIG. 8 shows the picker from the top in front of a tape cartridge. The RFID-Chip is in the house of the tape cartridge. The transceiver is moved along the tapes to detect if a tape is present. The robotic allows that the elevator can lift the picker comprising the transceiver.

While the best mode for carrying out the invention has been described in detail, those familiar with the art to which this invention relates will recognize various alternative designs and embodiments for practicing the invention within the scope of the appended claims.

What is claimed is:

1. A method of auditing cartridges and empty cells in a storage library system including a plurality cells for storing cartridges and further including a robotically actuated picker assembly, the method comprising:
providing a radio frequency sensor on the picker assembly;
positioning a cartridge having at least one radio emitting chip within the cells so that the presence of the radio emitting chip can be detected without unloading the cartridge from the cells and
operating the picker in a manner to search for the presence of the radio emitting chip within each cell for auditing numbers of cartridges and empty cells in the storage library system
by moving the picker with the radio frequency sensor from one cell to the next to measure the presence of the radio emitting chip for each cell.

2. The method of claim 1, wherein the chip is a memory chip being reprogrammable by a high frequency.

3. The method of claim 2, wherein the chip is a memory chip including information to calibrate the tape drive.

4. The method of claim 3, wherein the chip is a 4 or 8 KB memory chip of a LTO tape cartridge.

5. The method of claim 1, wherein the chip uses the power of a radio carrier signal to operate and the energy consumption of the chip is measured by the radio frequency sensor to detect the presence of the chip.

6. The method of claim 5, wherein the radio frequency sensor comprises an antenna which is moved along the cells, wherein a load change indicates a cartridge within a cell.

7. The method of claim 5, wherein the load change is measured analogues.

8. The method of claim 1, wherein the interpretation of measured information is performed in relation to the position of the picker to eliminate errors.

9. The method of claim 8, wherein the location of the cell and the location of the chip within or on the cartridge allows calculating the closest possible position of the radio frequency sensor to the chip inducing the strongest signal and allowing to eliminate errors if the sensor is too far away from a possible chip.

10. The method of claim 1, wherein the moving path of the robotically actuated picker assembly is calculated based on the location of the cell and the location of the chip within or on the cartridge to determine the shorts path allowing the closest possible position of the radio frequency sensor to the chip.

11. The method of claim 1, wherein the carrier signal of the radio frequency sensor is generated by oscillator to match the resonant frequency of the chip.

12. An apparatus for auditing cartridges and empty cells in a storage library system including a plurality of cells for storing cartridges and further including a robotically actuated picker assembly, the apparatus comprising:
a the radio frequency sensor secured to the picker assembly; and
cartridges having at least one radio emitting chip within the cells so that the presence of the radio emitting chip can be detected without unloading the cartridge from the cells
operating the picker in a manner to search for the presence of the radio emitting chip within each cell for auditing numbers of cartridges and empty cells in the storage library system by moving the picker with the radio frequency sensor from one cell to the next and measuring the presence of the radio emitting chip for each cell.

13. The apparatus of claim 12, wherein the radio frequency sensor emits a radio carrier signal to operate the chip and the energy consumption of the chip is measured by a measurement unit of the radio frequency sensor to detect the presence of the chip.

14. The apparatus of claim 13, wherein the radio frequency sensor comprises an antenna which is moved along the cells, wherein a load change indicates a cartridge within a cell.

15. The apparatus of claim 14, wherein a measurement unit measure the load change analogues.

16. The apparatus of claim 13, wherein a processing unit interprets the measured information in relation to the position of the picker to eliminate errors.

17. The apparatus of claim 16, wherein the processing unit calculates based on the location of the cell and the location of the chip within or on the cartridge the closest possible position of the radio frequency sensor to the chip inducing the strongest signal eliminating errors if the sensor is too far away from a possible chip.

18. The apparatus of claim 12, comprising a processing circuitry to calculate the moving path of the robotically actuated picker assembly based on the location of the cells and the location of the chips within or on the cartridge to determine a short path allowing the closest possible position of the radio frequency sensor to the chip.

19. The apparatus of claim 12, comprising an oscillator to generate the carrier signal of the radio frequency sensor to match the resonant frequency of the chip.
